(19) United States
(12) Patent Application Publication
(10) Pub. No.: US 2012/0299818 A1
(43) Pub. Date: Nov. 29, 2012

(54) MEDICAL INFORMATION DISPLAY APPARATUS, OPERATION METHOD OF THE SAME AND MEDICAL INFORMATION DISPLAY PROGRAM

(75) Inventors: Yuanzhong Li, Tokyo (JP); Tsuyoshi Hirakawa, Tokyo (JP); Takuya Ebina, Tokyo (JP); Jun Masumoto, Tokyo (JP); Hajime Shirasaka, Tokyo (JP)

(73) Assignee: FUJIFILM Corporation, Tokyo (JP)

(21) Appl. No.: 13/480,337

(22) Filed: May 24, 2012

(30) Foreign Application Priority Data
May 26, 2011 (JP) 117543/2011

(51) Int. Cl. G06F 3/01

(52) U.S. Cl. 345/156

(57) ABSTRACT

One of hierarchical images constituted by an appearance image representing an appearance of a subject body and a plurality of gradually magnified anatomy images schematically representing anatomical structures present inside of the body is displayed on a display unit. If a structure present at a desired position in the displayed image on the display unit specified by the specification input corresponds to a target examined region, the displayed image is switched to the examination information associated with the target examined region to display the examination information.

### BACKGROUND OF THE INVENTION

1. Field of the Invention

The present invention relates to a technology for displaying medical information desired by a user using a graphical user interface.

2. Description of the Related Art

A wide variety of medical information, including textual information, such as medical records, and other data, such as image information obtained by various modalities, such as CT, MRI, US, PET, and the like, waveform information, such as electrocardiograms, electroencephalograms, and the like, and various medical examination reports, are accumulated in medical front offices as electronic data.

In addition, a system in which each medical institution is allowed to access medical information stored in a dedicated server in each institution via a service center has been provided. For example, associated institutions that disclose information, such as core hospitals and the like, and institutions that gain access to view information are linked to the service center via a security protected VPN or SSL network and the service center performs location management of medical information, like which patient information is stored in which medical institution server, and management of patient ID links and access right to medical information with respect to each medical institution.

Each medical institution may share medical information of a patient distributed in local medical institutions on a list displayed screen by entering ID of the patient. This allows medical images to be viewed by DICOM Viewer, as well as prescriptions and examination data. Further, a certain system also shares document files to make them available to viewing institutions, such as clinics and the like.

Various types of user interfaces are proposed as a technique for facilitating selection and confirmation of such a huge amount of medical information. For example, a user interface in which a region in a human-like shape or a region in an image representing a portion of a human body displayed on a display screen is specified by a pointing device to extract medical images of diseased regions at and around the specified region from medical information database and to display a list screen of the extracted medical images is known as described, for example, in Japanese Unexamined Patent Publication No. 2003-260030.

In the user interface described in Japanese Unexamined Patent Publication No. 2003-260030, a region of a human body is specified in an outline human body view to obtain medical information of the specified region. In the case where organs are present in an overlapping manner at the specified portion, however, medical information of an organ other than the intended organ might be obtained by chance. Further, if the disease is a chronic disease, medical examination is performed repeatedly and many examination results are obtained if only the region is specified.

The present invention has been developed in view of the circumstances described above, and it is an object of the present invention to provide a medical image display apparatus, method, and program capable of easily confirming an examination result of a disease of a patient received at a given time.

### SUMMARY OF THE INVENTION

A medical information display apparatus of the present invention is an apparatus, including:

a time-line display unit for displaying a time-line representing a time axis on a display unit;

a time-line specification input acceptance unit for accepting a specification input specifying a given period on the time-line;

an electronic medical record retrieval unit for retrieving an electronic medical record of a given subject for an examination received by the subject during the specified period from an electronic medical record storage unit storing numbers of electronic records;

a target examined region extraction unit for extracting an examined region recorded in the retrieved electronic medical record;

an examination information retrieval unit for retrieving examination information associated with the examined region from an examination information storage unit storing numbers of examination information;

a hierarchical image storage unit storing hierarchical images constituted by an appearance image representing an appearance of a body and a plurality of gradually magnified anatomy images schematically representing anatomical structures present inside of the body in which the plurality of anatomy images is ranked such that the higher the magnification rate the lower is the rank with the appearance image being ranked highest;

a hierarchical image display unit for displaying one of the hierarchical images on the display unit;

a specification input acceptance unit for accepting a specification input specifying a desired position in the image displayed on the display unit;

a hierarchical image switch and display control unit for switching the image displayed by the hierarchical image display unit to an anatomy image ranked lower than the displayed image to display the anatomy image according to the specification input accepted by the specification input acceptance unit in which an image including a structure present at the specified position in the switched anatomy image is displayed on the display unit; and

an examination information switch and display control unit for switching the image displayed by the hierarchical image display unit to the retrieved examination information to display the examination information if the structure present at the position specified by the specification input accepted by the specification input acceptance unit corresponds to the examined region.

An operation method of the present invention for operating the aforementioned medical information display apparatus is a method, including:

a time-line display step for displaying, by the time-line display unit, a time-line representing a time axis on a display unit;

a time-line specification input accepting step for accepting, by the time-line specification input acceptance unit, a specification input specifying a given period on the time-line;

an electronic medical record retrieval step for retrieving, by the electronic medical record retrieval unit, an electronic medical record of a given subject for an examination received by the subject during the specified period from an electronic medical record storage unit storing numbers of electronic records;

a target examined region extraction unit for extracting an examined region recorded in the retrieved electronic medical record;

an examination information retrieval step for retrieving, by the examination information retrieval unit, examination information associated with the examined region from an examination information storage unit storing numbers of examination information;

a hierarchical image display step for displaying, by the hierarchical image display unit, one of the hierarchical images on the display unit;

a specification input accepting step for accepting, by the specification input acceptance unit, a specification input specifying a desired position in the image displayed on the display unit;

a hierarchical image switch and display control step for switching, by the hierarchical image switch and display control unit, the image displayed by the hierarchical image display unit to an anatomy image ranked lower than the displayed image to display the anatomy image according to the specification input accepted by the specification input acceptance unit in which an image including a structure present at the specified position in the switched anatomy image is displayed on the display unit; and

an examination information switch and display control step for switching, by the examination information switch and display control unit, the image displayed by the hierarchical image display unit to the retrieved examination information to display the examination information if the structure present at the position specified by the specification input accepted by the specification input acceptance unit corresponds to the examined region.

A medical information display program of the present invention is a program for causing a computer to function as:

a time-line display unit for displaying a time-line representing a time axis on a display unit;

a time-line specification input acceptance unit for accepting a specification input specifying a given period on the time-line;

an electronic medical record retrieval unit for retrieving an electronic medical record of a given subject for an examination received by the subject during the specified period from an electronic medical record storage unit storing numbers of electronic records;

a target examined region extraction unit for extracting an examined region recorded in the retrieved electronic medical record;

an examination information retrieval unit for retrieving examination information associated with the examined region from an examination information storage unit storing numbers of examination information;

a hierarchical image storage unit storing hierarchical images constituted by an appearance image representing an appearance of a subject body and a plurality of gradually magnified anatomy images schematically representing anatomical structures present inside of the body in which the plurality of anatomy images is ranked such that the higher the magnification rate the lower is the rank with the appearance image being ranked highest;

a hierarchical image display unit for displaying one of the hierarchical images on the display unit;

a specification input acceptance unit for accepting a specification input specifying a desired position in the image displayed on the display unit;

a hierarchical image switch and display control unit for switching the image displayed by the hierarchical image display unit to an anatomy image ranked lower than the displayed image to display the anatomy image according to the specification input accepted by the specification input acceptance unit in which an image including a structure present at the specified position in the switched anatomy image is displayed on the display unit; and

an examination information switch and display control unit for switching the image displayed by the hierarchical image display unit to the retrieved examination information to display the examination information if the structure present at the position specified by the specification input accepted by the specification input acceptance unit corresponds to the examined region.

The term “appearance image” as used herein refers to a schematic image representing an appearance of a human body in which a standard shape of a human body, including a head section, chest section, arms, legs and, the like, is represented.

The medical information display apparatus of the present invention may further include an examined region mark display unit for displaying a mark representing the extracted examined region on a position in the appearance image corresponding to the extracted examined region in a superimposing manner.

Preferably, the examination information switch and display control unit is a unit that switches the image displayed by the hierarchical image display unit to the retrieved examination information to display the examination information only when the image displayed by the hierarchical image display unit is an anatomy image magnified by a predetermined magnification rate or greater.

Preferably, the hierarchical image switch and display control unit is a unit that displays the image including a structure corresponding to the examined region if the structure corresponding to examined region is present adjacent to the position specified by the specification input acceptance unit.

The time-line specification input acceptance unit may be a unit that accepts an input from any one of a mouse, keyboard, and touch panel provided on the display unit.

The specification input acceptance unit may be a unit that accepts an input from any one of a mouse, keyboard, and touch panel provided on the display unit.

The examination information may be a medical image.

According to the present invention, examination information corresponding to a region of a patient examined during a medical examination reception period may be retrieved and displayed automatically by specifying the medical examination reception period in an appearance image, then switching the appearance image to an anatomy image, and specifying an examined region for which the examination information is desired to be confirmed in the anatomy image. This allows an organ of examined region for which the examination information is desired to be confirmed to be directly specified in the anatomy image, whereby the examination information of examined region to be confirmed may be reliably specified and displayed. The magnified view of the anatomy image allows an examined region hidden by another organ or a small examined region to be reliably specified.

Further, superimposed display of a mark representing an examined region in an appearance image allows instantaneous confirmation of a region examined during a medical examination reception period.

Still further, the displayed image is switched to the retrieved examination information to display the examination information only when the examined region is specified in an anatomy image magnified by a predetermined magnification rate or greater, that is, only when the examined region is displayed on the screen in an enlarged manner and the displayed examined region is selected. That is, the examination information may be displayed only when the examined region for which the examination information is desired to be confirmed is specified firmly by the operator.

### BRIEF DESCRIPTION OF THE DRAWINGS

FIG. 1 illustrates a configuration of a medical information integration system, including a medical information display apparatus according to an embodiment of the present invention, and peripheral systems.

FIG. 2 illustrates, by way of example, an external view of a medical image display apparatus according to a first embodiment.

FIG. 3 is a block diagram of major components of the medical image display apparatus and a medical information management server according to the first embodiment of the present invention.

FIG. 4 illustrates, by way of example, hierarchical images.

FIG. 5A is a flowchart illustrating a medical information display processing flow performed in the medical information integration system according to the first embodiment of the present invention (Part 1).

FIG. 5B is a flowchart illustrating a medical information display processing flow performed in the medical information integration system according to the first embodiment of the present invention (Part 2).

FIG. 6 illustrates, by way of example, a display screen of a display unit of the medical information display apparatus 1 according to the first embodiment of the present invention.

FIG. 7 illustrates, by way of example, the case where examination information is displayed on the display screen of the display unit of the medical information display apparatus 1.

FIG. 8 is a block diagram of major components of a medical image display apparatus and a medical information management server according to a second embodiment of the present invention.

FIG. 9A is a flowchart illustrating a medical information display processing flow performed in a medical information integration system according to the second embodiment of the present invention (Part 1).

FIG. 9B is a flowchart illustrating a medical information display processing flow performed in a medical information integration system according to the second embodiment of the present invention (Part 2).

FIG. 10 illustrates, by way of example, a display screen of a display unit of the medical information display apparatus 1 according to the second embodiment of the present invention.

FIG. 11 illustrates a configuration to be employed in the case where a medical information management system of the present invention integrally manages patient medical information dispersed in other medical institutions.

FIG. 12 illustrates a configuration to be employed in the case where a patient gains access to the medical information management system of the present invention from his/her home.

### DESCRIPTION OF THE PREFERRED EMBODIMENTS

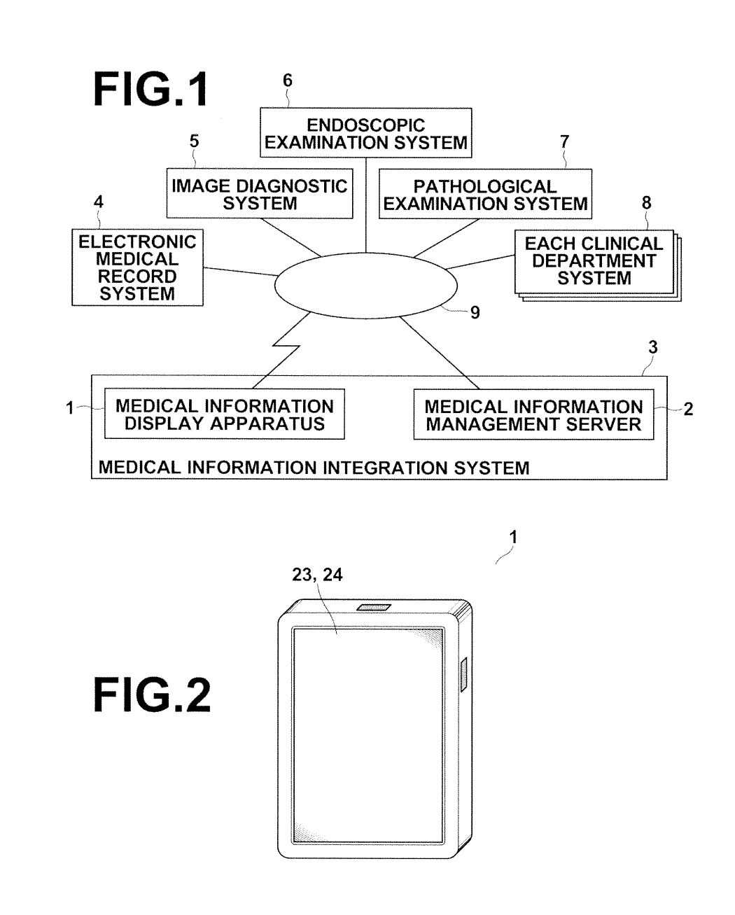

FIG. 1 illustrates a configuration of a medical information integration system 3, including a medical information display apparatus 1 according to an embodiment of the present invention, and peripheral systems. As illustrated in the drawing, the medical information integration system 3 is communicatively linked to an electronic medical record system 4, an image diagnostic system 5, an endoscopic examination system 6, a pathological examination system 7, and each clinical department system 8 via a network 9. The medical information integration system 3 includes a medical information display apparatus 1 and a medical information management server 2 according to an embodiment of the present invention.

In the present embodiment, medical information generated in the electronic medical record system 4, image diagnostic system 5, endoscopic examination system 6, pathological examination system 7, and each clinical department system 8 is integrally managed by the medical information management server 2. The medical information display apparatus 1 makes a request to the medical information management server 2 for medical information and displays the medical information provided by the medical information management server 2 in response to the request.

The medical information display apparatus 1 is a computer, such as a workstation or the like, and has a known hardware configuration, including a CUP, main storage unit, auxiliary storage unit, I/O interface, communication interface, input devices (mouse, keyboard, and the like), display unit (display monitor, liquid crystal display, or the like), data bus, and the like with a known operating system or the like being installed thereon. A display having a touch panel with a GUI which allows data entry by a finger operation is preferably used as the display unit.

As for the touch panel, any known type may be used, such as resistive, capacitive, electromagnetic, surface acoustic wave (ultrasonic), infrared, or the like. In order for a wide variety of finger operations to be distinguished, a multi-touch (touches at a plurality of positions) detectable panel, such as a projected capacitive touch panel or the like, is preferably used.

Further, the medical information display apparatus 1 may be a tablet terminal, such as that shown in FIG. 2 having a liquid crystal display 24 in front integrally formed with a touch panel 23. The tablet terminal is a portable computer and communication between the medical information display apparatus 1 and the medical information management server 2 is performed via a known cellular communication network, a wireless LAN, or the like.

In the meantime, the medical information management server is a computer having a medical information database with application software for medical information registration in and extraction from the database, as well as a known operating system and database management software, being installed thereon.

The electronic medical record system 4 employs a known computer system and includes an electronic medical record management server 41, with an electronic medical record database having therein electronic medical records, which is communicatively linked, for example, to a terminal of each clinical department and the like via the network 9, and an electronic medical record entered at the terminal of each clinical department or the like is managed using the electronic medical record database.

The electronic medical record includes, for example, patient information, including patient name, date of birth, gender, and the like; examined region information; date of each examination; examination order information, including examination instruction content and the like; date of examination; diagnosis information, including major complaint and determined disease name, and the like; date of treatment, such as operation, procedure, medication; treatment information, including treatment content; and the like. The electronic medical record database has a database structure in which a patient ID for identifying each patient is associated with the aforementioned electronic medical record.

Examinations may include endoscopic examination, pathological examination, and image diagnosis performed in an examination room away from each clinical department, as well as electrocardiogram recording performed in each clinical department. The examination order information includes type of examination and detailed instruction, and examination information, such as a medical image taken according to the examination order and a result of examination performed by the examination order, is managed by the image diagnostic system 5, endoscopic examination system 6, pathological examination system 7, and the like. The examination information such as a result of examination performed in each clinical department is managed by the each clinical department system 8.

The image diagnostic system 5 also employs a known computer system and has a configuration in which, for example, an image diagnosis medical workstation, an image management server 51 with an image database having therein images obtained by CT, MRI, and the like, and a radiology report server 52 with a radiology report database having therein radiology reports which include interpretation results of images obtained by imaging are communicatively linked via the network 9. Here, the image diagnosis medical workstation may perform known image processing such as MIT, MPR, CPR, volume rendering (VR), or the like according to the purpose or target of diagnosis in combination with a known image analysis, such as bone extraction/elimination, blood vessel extraction, organ extraction, detection of abnormal tissue pattern, or the like, and these processed/analyzed images are also stored in the image database. The images may include both two-dimensional image (pixel data) and three-dimensional image (voxel data), and both still image and moving picture. In addition to the patient ID, the image database includes other auxiliary information associated with each image, such as an image ID for identifying each image, modality information by which the image is obtained, region information of a subject in the image, and the like. The modality information is provided by the modality at the time of image generation. The region information of a subject may be provided by the modality at the time of image generation based on the examination order or the like or, if the image is a tomographic image, such as a CT image or the like, the region information may be provided by the image diagnosis medical workstation for each slice using a known region recognition technique, such as that described in Japanese Unexamined Patent Publication NO. 2008-259682. The radiology report database has a database structure in which each radiology report, patient ID, and interpretation target image are associated with each other. Each image or radiology report may be indirectly associated with the patient ID by way of the examination order information identifying each examination (imaging).

The endoscopic examination system 6 also employs a known computer system and includes an endoscopic examination management server 61 with an endoscopic examination database having therein real endoscope images obtained by endoscopes of various types, endoscopic examination reports which includes results of endoscopic examinations, and the like associated with the examination order information and patient IDs, and access control to the endoscopic examination database is performed by the server 61.

The pathological examination system 7 also employs a known computer system and includes a pathological examination management server 71 with a pathological examination database having therein microscope images obtained by pathological examinations, pathological examination reports which includes results of pathological examinations, and the like associated with examination order information and patient IDs, and access control to the pathological examination database is performed by the server 71.

The each clinical department system 8 includes a clinical department examination management server 81 with each clinical department database having therein examination data, examination reports, and the like obtained in each clinical department associated with the examination order information and patient IDs, and access control to the each clinical department database is performed by the server 81. The examination data obtained in each clinical department may be, for example, electrocardiogram data and the like (waveforms, numerical values, or the like) if the clinical department is a cardiovascular department, auditory test data and the like (waveforms, numerical values, or the like) if the department is an otolaryngology department, or visual acuity test data, fundus examination data or the like (numerical values, or the like) if the department is an ophthalmology department.

In the first embodiment, a description will be made of a case in which medical information is obtained from the medical information management server 2 in response to and in accordance with a request from the medical information display apparatus 1 and the obtained medical information is displayed on the display unit of the medical information display apparatus 1. The examination information is assumed to include an image obtained by a modality, processed image, real endoscope image, microscope image, radiology report, endoscopic examination report, pathological examination report, electrocardiogram data (waveform, numerical values, or the like), auditory test data (waveform, numerical values, or the like), visual acuity test data, fundus examination data, and the like. Further, a description will be made on the assumption that the examination information storage means of the present invention is constituted by the image management server 51, radiology report server 52, endoscopic examination management server 61, pathological examination management server 71, and clinical department examination management server 81.

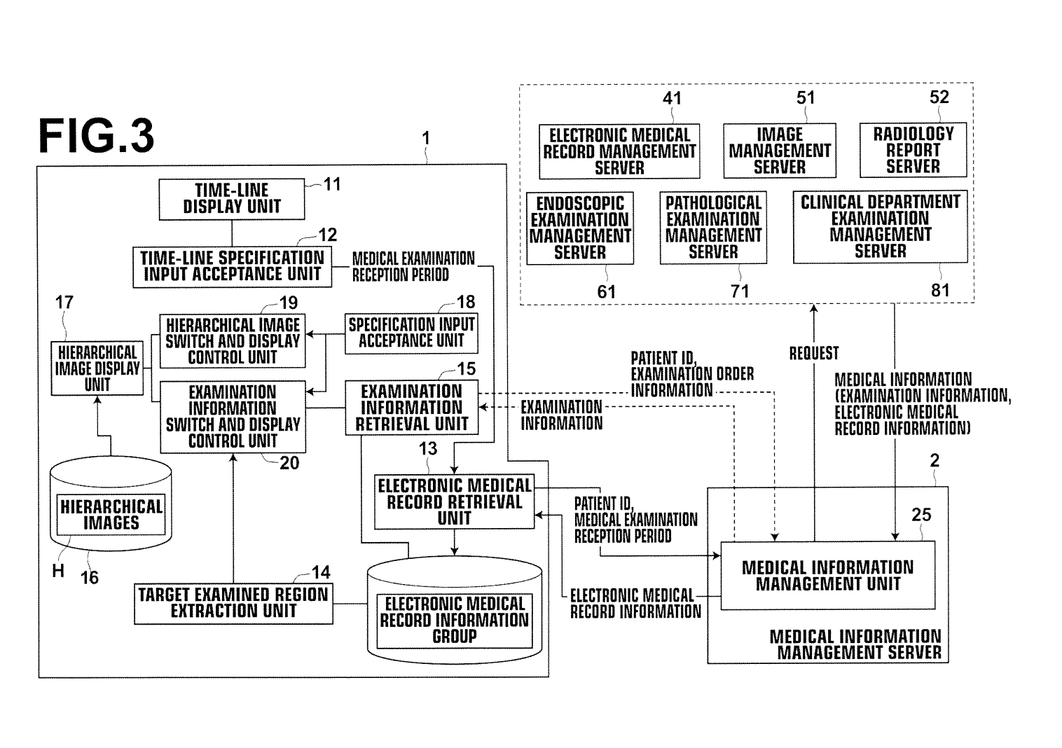

FIG. 3 is a block diagram of the medical information display apparatus 1 and the medical information management server 2 according to the first embodiment, schematically illustrating functions installed thereon. As illustrated, the medical information display apparatus 1 of the first embodiment of the present invention includes a time-line display unit 11, a time-line specification input acceptance unit 12, an electronic medical record retrieval unit 13, target examined region extraction unit 14, an examination information retrieval unit 15, a hierarchical image storage unit 16, a hierarchical image display unit 17, a specification input acceptance unit 18, a hierarchical image switch and display control unit 19, examination information switch and display control unit 20.

The medical information management unit 25 of the medical information management server 2 performs location management of medical information generated by other systems (electronic medical record system 4, image diagnostic system 5, endoscopic examination system, pathological examination system 7, and each clinical department system) based on the patient ID, in which it makes requests to other systems for medical information and obtains the information.

In the first embodiment, a display method performed in the following manner will be described. That is, hierarchical images constituted by an appearance image and an anatomy image are provided, an appearance image of a human body is displayed first, then when an examined region is specified in the appearance image, the displayed appearance image is switched to an anatomy image of the examined region to display the anatomy image, and when the examined region is specified in the anatomy image, the displayed anatomy image is switched to examination information, such as an examination result and the like obtained by examining the specified organ or tissue, to display the examination information.

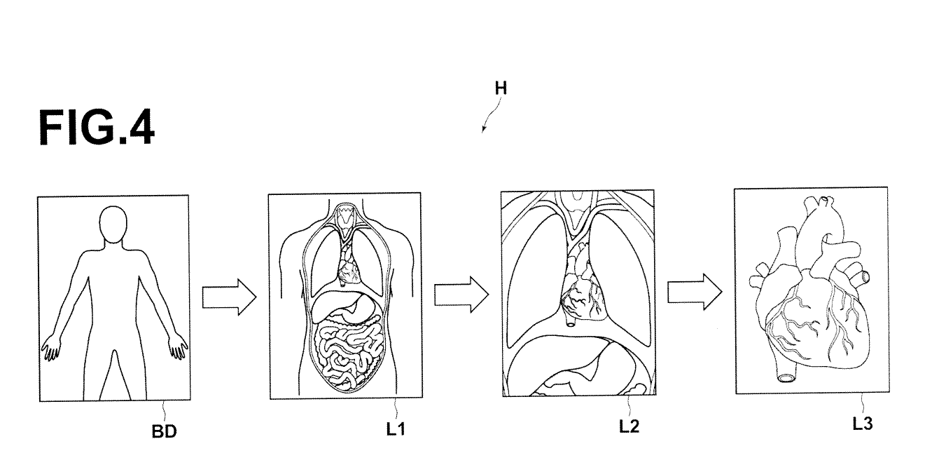

FIG. 4 illustrates, by way of example, a structure of hierarchical images. The hierarchical images H include an appearance image BD representing a human body and a plurality of anatomy images L1, L2, and L3, each schematically representing anatomical structures inside of the body. Images of different magnification rates are provided as the anatomy images L1, L2, and L3. The anatomy images are ranked such that an anatomy image with a small magnification rate is ranked high in the hierarchy and ranked lower in the hierarchy as the magnification rate is increased with the appearance image BD ranked in highest in the hierarchy.

In addition to the images simply changed in magnification rate, a plurality of anatomy images schematically representing, step by step, organs and tissues appearing when a human body is anatomized ranging from an image of a portion near the surface of the human body to a specific organ or tissue is provided as the anatomy images L1, L2, and L3 constituting the hierarchical images H. These anatomy images L1, L2, and L3 are ranked such that the closer the image to the body surface the higher is the rank. For example, an anatomy image representing a muscle directly under the skin of a human body, an anatomy image representing ribs under the muscle, an anatomy image representing a lung or heart under the ribs, and an anatomy image representing one organ, such as a heart, in detail are provided. The anatomy image in each stage is gradually magnified so that each organ or tissue can be sufficiently recognized. Although, only three anatomy images L1, L2, and L3 are shown in FIG. 4 for the sake of simplicity, it is preferable that multiple anatomy images of different magnification rates be provided.

The same organ or tissue in the anatomy image in each rank is linked to each other. Further, in the case where an organ “n” is hidden by an organ “m” and does not appear in an anatomy image in a certain rank but appears in an anatomy image in the immediately lower rank, the organ “m” hiding the organ “n” in the anatomy image in the upper rank is linked to the organ “m” in the anatomy image in the immediately lower rank are linked, so that if the position of the organ “n” is specified in the anatomy image in the upper rank, the organ “n” in the anatomy image in the lower rank is displayed. In the case of the appearance image BD, the position of an organ under the appearance image BD viewed from the body surface is linked to the organ in the anatomy image in the immediately lower rank. The hierarchical image switch and display control unit 19, to be described later, performs switching and display control based on the links of the hierarchical images H.

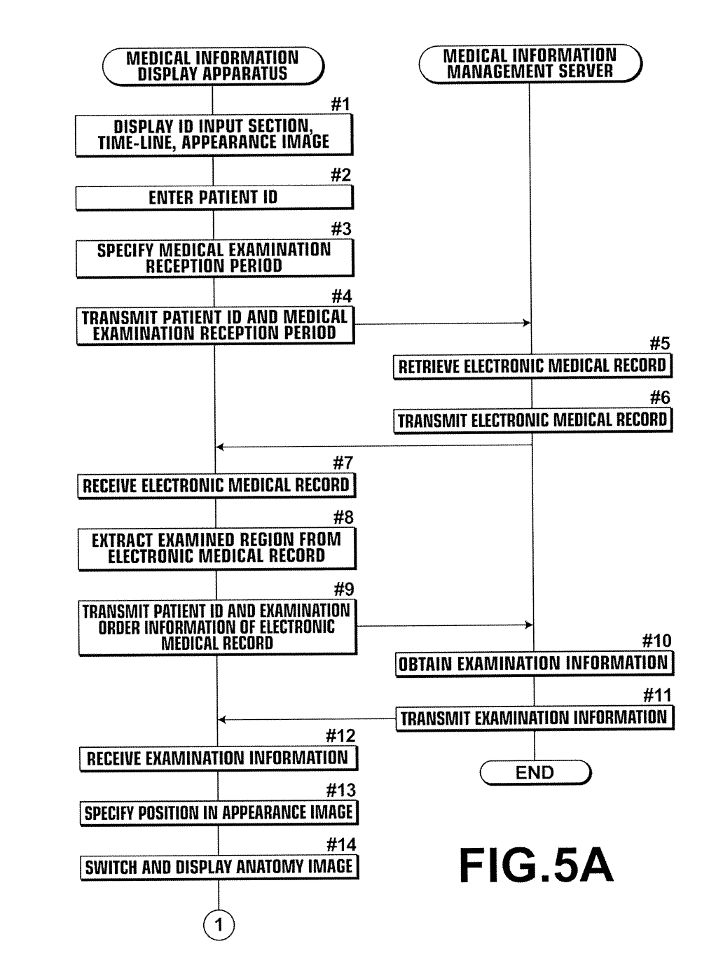

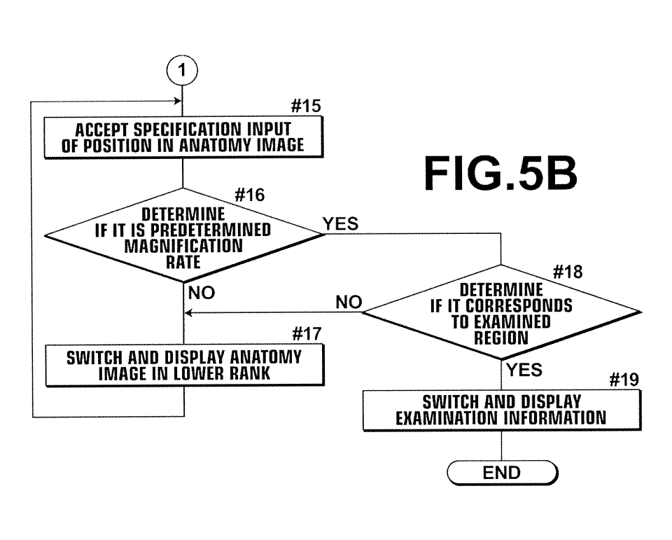

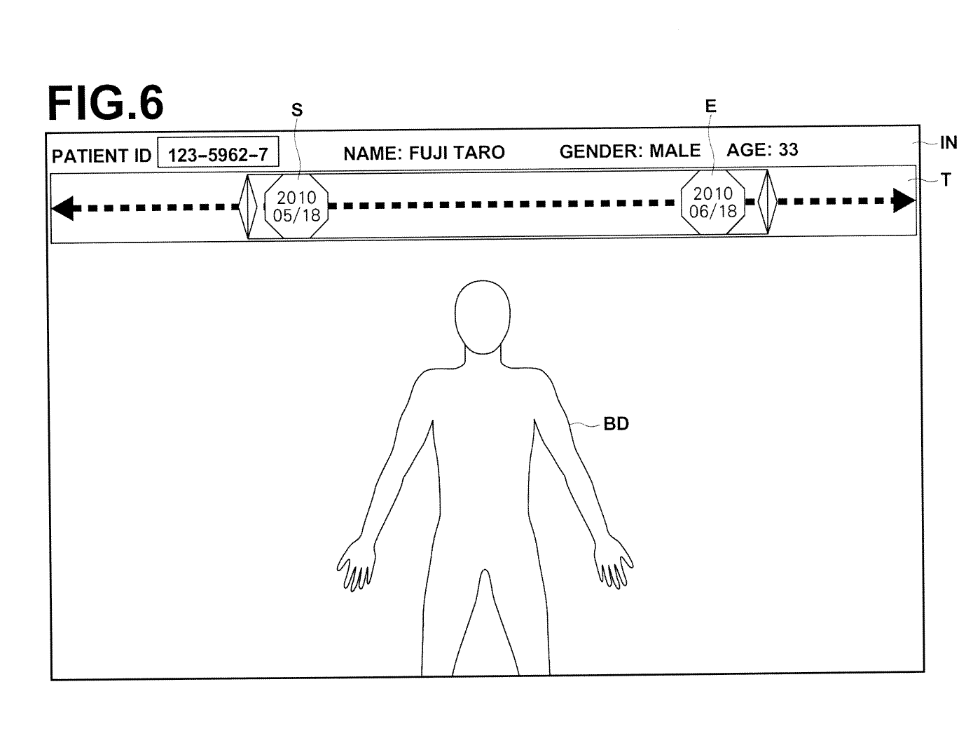

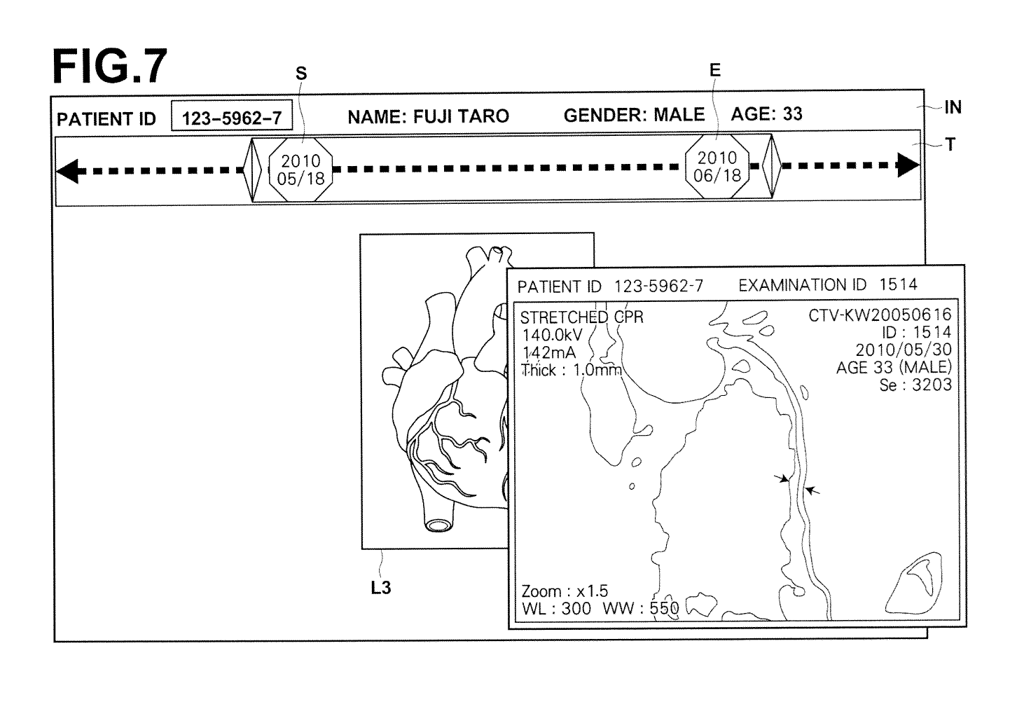

FIGS. 5A and 5B show a flowchart illustrating a flow of processing performed in the medical information integration system 3. FIG. 6 illustrates, by way of example, a display screen of a display unit of the medical information display apparatus 1 and FIG. 7 shows an example case in which examination information is displayed on the display screen of the display unit of the medical information display apparatus 1.

With reference to FIGS. 3 to 7, an overall flow of medical information display processing, each processing performed in the medical information display apparatus 1, and each processing performed in the medical information management unit 25 will be described.

As shown in FIG. 6, a patient ID input section IN is displayed on the display screen of the display unit of the medical information display apparatus 1. Further, a time-line T representing a time axis is displayed in an upper section on the display screen by the time-line display unit 11. The hierarchical image display unit 17 displays an appearance image BD of a human body of hierarchical images stored in the hierarchical image storage unit 16 below the time-line T (#1).

First, a doctor enters a patient ID in the input section IN using a keyboard (#2). Then, the doctor puts a mark S indicating the start date of a recent medical examination received by the patient and a mark E indicating the final date of medical examination on the time-line T of the display screen using a mouse, thereby fixing the period between the marks as a medical examination reception period.

In the case where the mark S is put on a position representing the date of May 18, 2010 and the mark E is put on a position representing the date of Jun. 18, 2010, the time-line specification input acceptance unit 12 accepts the period from the date of May 18, 2010 to the date of Jun. 18, 2010 as the medical examination reception period (#3). Alternatively, an arrangement may be adopted in which one month is determined as the default medical examination reception period in advance, and when the most recent examination date is entered, one month period before the data on which the mark is placed is accepted as the medical examination reception period. The time-line specification input acceptance unit 12 is not limited to the mouse, and it is possible to accept the medical examination reception period through a touch panel provided on the display unit or a keyboard operation.

Then, electronic medical record retrieval unit 13 transmits the medical examination reception period and patient ID to the medical information management server 2 to request an electronic medical record of the patient identified by the patient ID during the medical examination reception period (#4). In response to the request, the patient ID and the specified medical examination reception period are transferred from the medical information management server 2 to the electronic medical record management server 41 of the electronic medical record system 4 and all electronic medical records with the specified patient ID and dates within the medical examination reception period are retrieved by the electronic medical record management server 41 (#5). The retrieved electronic medical records are transmitted from the electronic medical record management server 41 to medical information display apparatus 1 via the medical information management server (#6), and the medical information display apparatus 1 temporarily stores the received electronic medical records in the auxiliary storage unit (#7).

The target examined region extraction unit 14 extracts an examined region based on the examined region information recorded in the electronic medical record (#8). In the case where the extracted examined region information is “heart”, heart is deemed to be the examined region. A description will be made of a case in which the examined region is heart.

The examination information retrieval unit 15 retrieves examination information associated with the electronic medical record stored in the auxiliary storage unit. The patient ID and examination order information are extracted from the electronic medical record, and the extracted patient ID and examination order information are transmitted to the medical information management server 2 to request the examination information (#9). In the case where the examination order information indicates imaging by CT, the medical information management server 2 transfers the patient ID and examination order information to the image management server 51 and obtains a CT image of heart (#10). Further, image management server 51 obtains not only the CT image but also a stretched CPR image of a coronary artery around the heart, MPR image, and the like obtained by processing the CT image at the image diagnosis medical workstation. The obtained CT image, stretched CPR image, MPR image, and the like are transmitted to the medical information display apparatus 1 via the medical information management server 2 (#11), and images received by the medical information display apparatus 1 are temporarily stored in the auxiliary storage unit (#12).

Next, the doctor clicks the mouse on a position near the heart of an appearance image BD displayed on the display unit in order to view the result of image diagnosis of the heart of the patient. The specification input acceptance unit 18 accepts the input of the position of the appearance image BD specified by the doctor (#13). The specification input acceptance unit 18 is not limited to the mouse, and it is possible to accept the position input through a touch panel provided on the display unit or a keyboard operation.

When the inputted position is accepted by the specification input acceptance unit 18, the hierarchical image switch and display control unit 19 switches the appearance image BD displayed by the hierarchical image display unit 17 to an anatomy image L1 one rank lower in the hierarchy to display the anatomy image L1. When performing the switching, the anatomy image L1 is displayed such that the image around the specified heart is placed in the approximate center of the display screen (#14). As the examined region extracted by the target examined region extraction unit 14, it is preferable that the anatomy image L1 be displayed such that the image of the heart is placed in the center of the display screen even when the position received by the specification input acceptance unit 18 differs slightly from the position of the heart. In the case where the position accepted by the specification input acceptance unit 18 is a position distant from that of the heart, an anatomy image of a magnified organ located at the specified position is displayed.

When the doctor clicks the mouse on an image near the heart in the displayed anatomy image L1, specification input acceptance unit 18 accepts the specified position (#15). If the displayed anatomy image is not magnified by a predetermined magnification rate (#16), the anatomy image L1 displayed by the hierarchical image display unit 17 is switched to an anatomy image L2 further one rank lower in the hierarchy by the hierarchical image switch and display control unit 19 such that the heart image is placed in the approximate center of the display screen (#17)

In the case where an organ of the examined region is shadowed by another organ and displayed only partially in an anatomy image displayed on the display unit or completely hidden by another organ, the organ of examined region may not always be specified.

Consequently, for example, even when the position accepted by the specification input acceptance unit 18 is pointing a lung, if the heart of the examined region is present under the lung at the specified position, the hierarchical image switch and display control unit 19 determines that the specifying operation is an operation for obtaining the examination information of the heart of the patient, which is the examined region, and displays an anatomy image L2 such that an image of the heart is placed in the approximate center of the display unit.

There may be a case in which an organ of examined region does not appear in a currently displayed anatomy image but is hidden under the organ displayed in the currently displayed anatomy image. For example, in the case where an anatomy image L1 is displayed with the lung being displayed in the center of the display screen but the heart of examined region is not displayed, even when the position accepted by the specification input acceptance unit 18 is a lung, if the heart of the examined region is present under the lung at the specified position, the hierarchical image switch and display control unit 19 determines that the specifying operation is an operation for obtaining the examination information of the heart of the patient, which is the examined region, and switches the currently displayed anatomy image L1 to an anatomy image L2 with the heart image being placed in the center of the display screen.

Above described steps are repeated to gradually magnify and display the target examined region (#15 to #17)

In the case where the displayed anatomy image reaches a predetermined magnification rate (#16) and the organ present at the position accepted by the specification input acceptance unit 18 corresponds to the examined region, that is, the heart (#18), the examination information switch and display control unit 20 switches the anatomy image displayed by the hierarchical image display unit 17 to examination information, such as a CT image, stretched CPR image, MPR image, or the like stored in the auxiliary storage unit to display the examination information (#19). As it is difficult to accurately specify an examined region in an anatomy image with a small magnification rate, the switching to the examination information is performed if the examined region is specified when an anatomy image magnified by a predetermined magnification rate or greater is displayed. In performing the switching to the examination information, the currently displayed anatomy image may be replaced with the examination information, or otherwise the examination information may be displayed by opening a new display window on the anatomy image. FIG. 7 shows an example case in which, when a heart in an anatomy image L3 of the hierarchical images H is clicked, a CT image of examination information is displayed in a separate display window.

In the case where a plurality of examination information is stored in the auxiliary storage unit, a plurality of windows is displayed on top of each other and different examination information is displayed in each display window. For example, a stretched CPR image may be displayed in the first display window, a MIP image may be displayed in the second display window, and a representative image of a CT image may be displayed in the third display window. The order of stacking the display windows is determined such that an image useful for diagnosis is displayed first according to the examined region or disease. Alternatively, a various known display methods may be employed, such as that in which examination information is switched and displayed in one display window by rotation.

In the case where the displayed anatomy image has reached a predetermined magnification rate but the organ at the position accepted by the specification input acceptance unit 18 does not correspond to the examined region, it can be said that the doctor intends to obtain examination information of an organ appearing in an image in a further lower rank in the hierarchy and, therefore, the hierarchical image switch and display control unit 19 switches the anatomy image displayed by the hierarchical image display unit 17 to an image in a further lower rank in the hierarchy to display the lower ranked image (#17).

Steps from #15 to #17 are repeated to display an anatomy image representing the organ of examined region and, when the organ of examined region is specified in the displayed anatomy image, the examination information is displayed by the examination information switch and display control unit 20.

In the case where the examination order information indicates imaging by a modality as described above, the patient ID and examination order information are sent to the image management server 51, and a pertinent medical image and variously processed images are obtained. Here, an arrangement may be adopted in which the patient ID and examination order information are also transferred to the radiology report server 52 to obtain a radiology report associated with the medical image obtained by the image management server 51, as required.

In the case where the examination order information indicates acquisition of a real endoscope image obtained by an endoscopic examination and an associated endoscopic examination report, a microscope image obtained by a pathological examination and an associated pathological examination report, or examination data, such as electrocardiograms and the like, obtained in each clinical department, the patient ID and examination order information are transferred from the medical information management server 2 to one of the endoscopic examination management server 61, pathological examination management server 71, or clinical department examination management server 81 according to the type of examination described in the examination order information. Then the requested examination information is obtained by a pertinent server 61, 71, or 81 and the obtained information is transmitted to the medical information display apparatus 1 via the medical information management server 2.

As described above, the doctor may automatically obtain examination information dispersed in the medical system based on the patient ID and medical examination reception period by selecting a region for which the doctor desires to confirm the examination result from an appearance image, displaying gradually magnified anatomy images, and specifying the organ of examined region. This may eliminate the need to perform complicated operations, as in the past, such as retrieving an electronic medical record using the patient ID, confirming the examined region recorded in the electronic medical record, and retrieving examination information based on the examination ID of the electronic medical record. Further, the organ of examined region for which the doctor desires to confirm the examination result can be directly specified in an anatomy image which eliminates the need to specify the examined region and examination ID, so that operation errors may be reduced and the examination information of the examined region required to be confirmed may be displayed reliably. Further, the magnified display of the anatomy image allows an examined region hidden by another organ or a small examined region to be specified reliably.

Next, a second embodiment will be described. In the second embodiment, a description will be made of a case in which a mark is displayed on a region examined during a medical examination reception period in an appearance image. Components identical those of the first embodiment are given the same reference numerals and will not be elaborated upon further here.

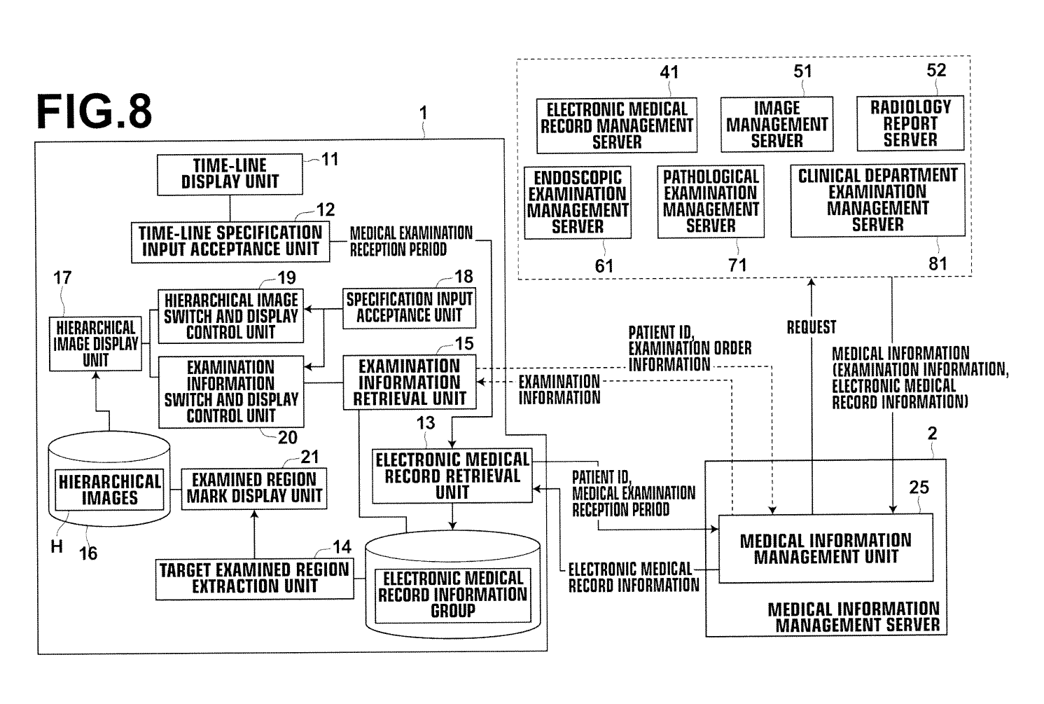

FIG. 8 is a block diagram of the medical information display apparatus 1 and the medical information management server 2 according to the second embodiment, schematically illustrating functions installed thereon. As illustrated, the medical information display apparatus 1 of the second embodiment of the present invention includes an examined region mark display unit 21 in addition to the time-line display unit 11, time-line specification input acceptance unit 12, electronic medical record retrieval unit 13, target examined region extraction unit 14, examination information retrieval unit 15, hierarchical image storage unit 16, hierarchical image display unit 17, specification input acceptance unit 18, hierarchical image switch and display control unit 19, and examination information switch and display control unit 20. The medical information management server 2 includes the medical information management unit 25.

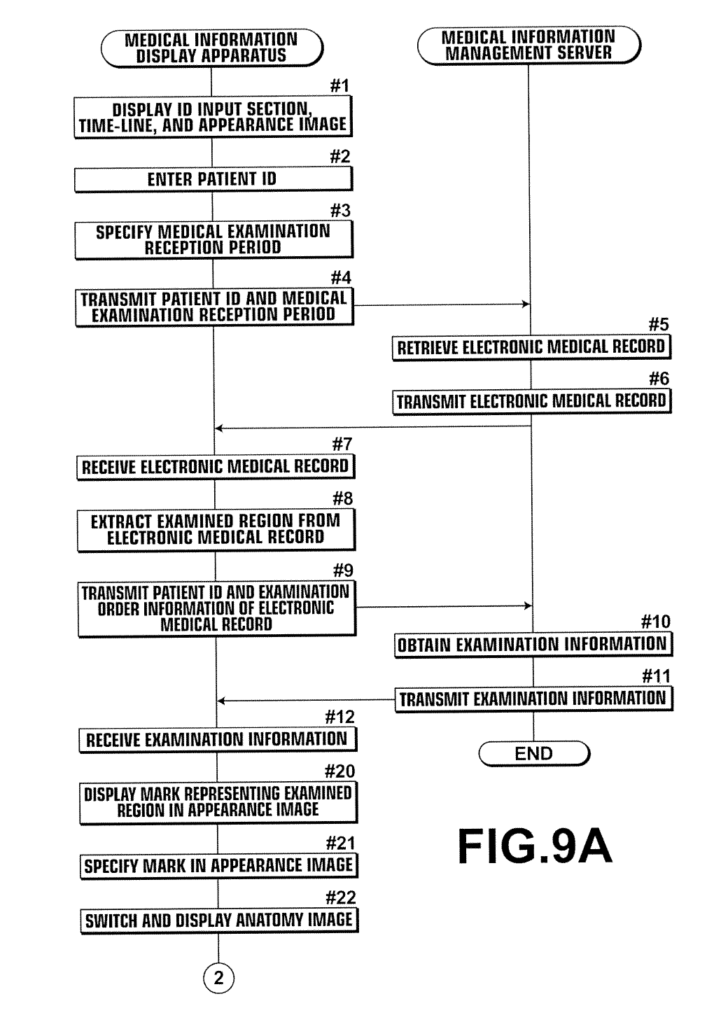

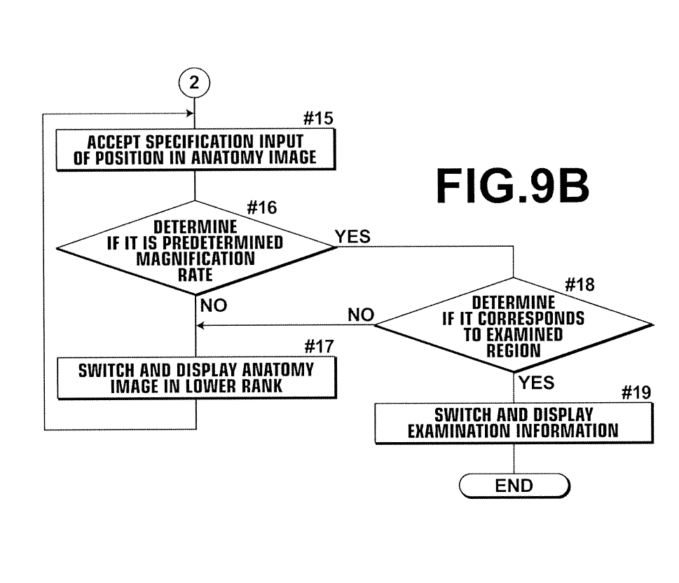

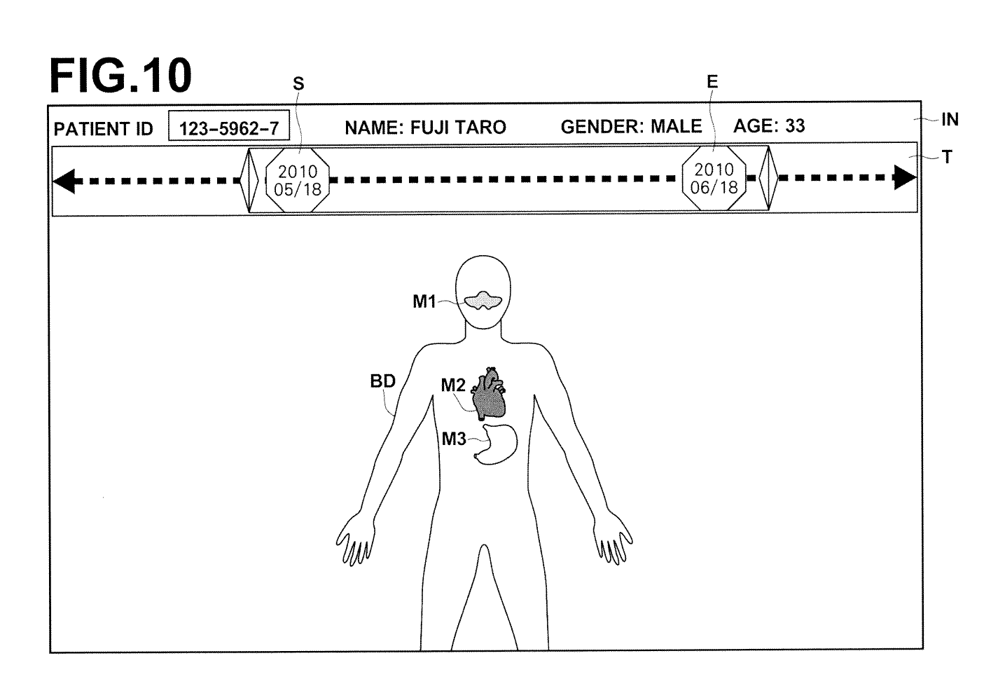

FIGS. 9A and 9B show a flowchart illustrating a flow of processing performed in the medical information integration system 3 of the second embodiment. FIG. 10 illustrates, by way of example, a display screen of a display unit of the medical information display apparatus 1 according to the second embodiment.

As in the first embodiment described above, the patient ID input section IN is displayed on the display screen of the display unit 1. Further, the time-line T representing a time axis is displayed in an upper section on the display screen by the time-line display unit 11. The hierarchical image display unit 17 displays an appearance image BD of a human body of a hierarchical image below the time-line T (#1)

As illustrated in FIG. 10, a patient ID is entered and a medical examination reception period is entered on the time-line, as in the first embodiment, to retrieve an electronic medical record corresponding to the patient ID and medical examination reception period, and the region examined during the medical examination reception period is extracted from the retrieved electronic medical record. Further, examination information corresponding to the electronic medical record is retrieved and stored in the auxiliary storage unit (#2 to #12)

There may be a case in which the patient has received medical examinations with respect to a plurality of organs like, for example, the heart and liver during the medical examination reception period, so that two or more examined regions may sometimes be extracted from a plurality of electronic medical records. Consequently, the present embodiment displays an examined region mark in the appearance image BD so that the region examined during the medical examination reception period is visually recognized.

The examined region mark display unit 21 displays marks M1, M2, M3 representing examined regions extracted by the target examined region extraction unit 14 on an appearance image BD displayed on a display unit in a superimposing manner (#20). As illustrated in FIG. 10, organ icons schematically representing the respective organs are preferably used as the marks M1, M2, M3 to allow instantaneous recognition of the organ represented by each mark. Further, an examined region which has received examination during the medical examination reception period but without any examination information and an examination region with examination information may be displayed in a distinguishable manner by, for example, displaying the color of the mark of the examined region without any examination information faintly while the color of the mark of the examined region with examination information strongly. Alternatively, the color of each mark representing each examined region may be changed according to whether or not examination information is provided for the examined region.

In the case where a doctor wants to confirm examination information of a patient, the doctor clicks a mouse on one of the marks of examined regions, for example, the mark representing the heart in an appearance image BD displayed on the display unit. The specification input acceptance unit 18 accepts that the heart is specified (#21). When the specification of the heart is accepted by the specification input acceptance unit 18, the hierarchical image switch and display control unit 19 switches the appearance image BD displayed by the hierarchical image display unit 17 to an anatomy image L1 one rank lower in the hierarchy (#22). The anatomy image is displayed such that an image of the heart is displayed in the approximate center of the display screen. Thereafter, as in the first embodiment, the anatomy image displayed by the hierarchical image display unit 17 is switched to anatomy images with higher magnification rates by the hierarchical image switch and display control unit 19 (#15 to #17).

In the case where the displayed anatomy image reaches a predetermined magnification rate (#16) and the organ present at the position received by the specification input acceptance unit 18 corresponds to the examined region, that is, the heart (#18), the anatomy image displayed by the hierarchical image display unit 17 is switched to examination information stored in the auxiliary storage unit to display the examination information (#19).

As described above, by displaying marks M1, M2, M3 of examined regions in the appearance image BD, a region that has examined during the medical examination reception period may be recognized instantaneously. Further, when the medical examination reception period is changed on the time-line, the marks of examined regions in the appearance image BD are also changed to those examined during the changed medical examination reception period. This allows past diseased regions of a patient to be recognized and selection of a mark of examined region allows examination information of the region at that time to be confirmed instantaneously without complicated operations.

In the embodiments above, the description has been made of a case in which real data of medical information are maintained in various systems, such as the electronic medical record system 4, image diagnostic system 5, endoscopic examination system 6, pathological examination system 7, each clinical department system 8, and the like, and the databases of those systems are used via the medical information management server 2. But, the real data may be centrally managed by the medical information management server 2.

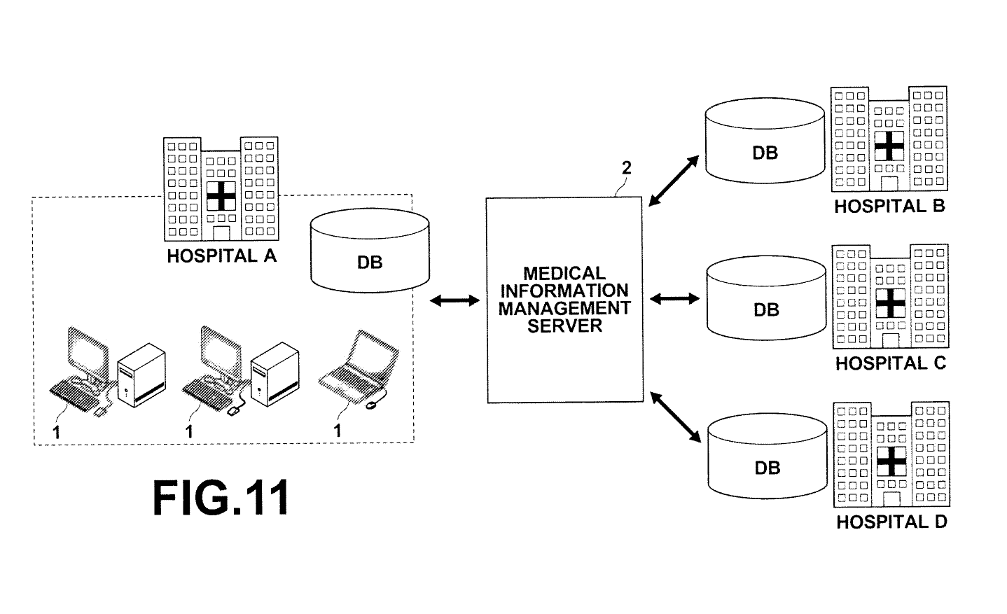

Further, in the aforementioned embodiments, the description has been made of a case in which a plurality of systems, including the electronic medical record system 4, image diagnostic system 5, endoscopic examination system 6, pathological examination system 7, and each clinical department system 8, installed in one medical institution are integrally managed. But, as illustrated in FIG. 11, medical information of a patient dispersed in local medical institutions (hospitals B, C, D) in addition to one medical institution (hospital A) may be integrally managed by performing management of link information associating the patient number (patient ID) with each medical institution and access right to medical information managed by each medical institution. This allows medical information of a patient for examinations received at a plurality of medical institutions to be viewed collectively and examination information of inspection requested to another medical institution to be confirmed instantaneously.

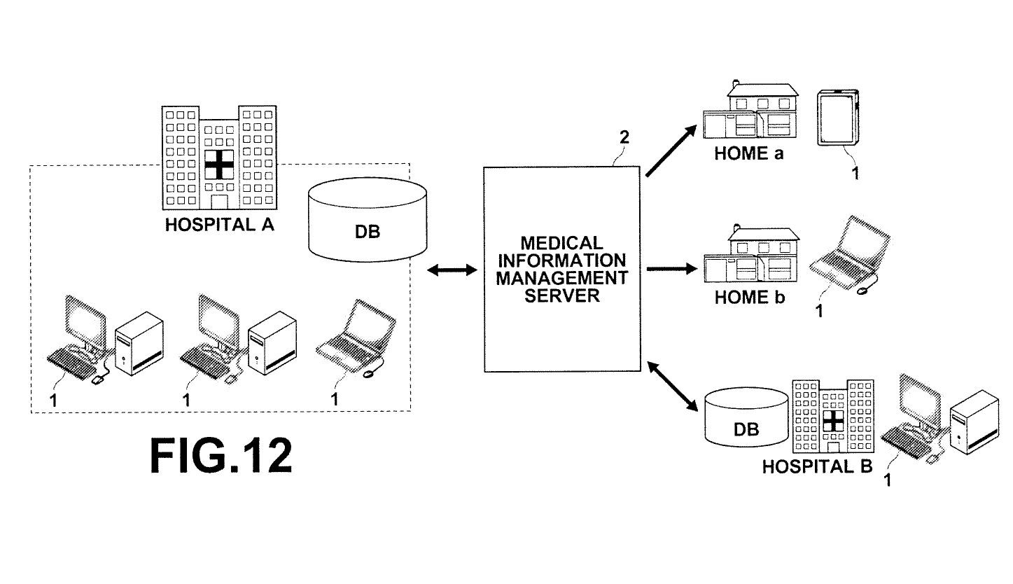

Still further, as illustrated in FIG. 12, an arrangement may be adopted in which home computers with a communication function, such as game machines, tablet terminals, and personal computers, are used as the medical information display apparatus 1, thereby allowing access to the medical information management server 2 from the home computers. This arrangement allows examination information for the examinations received at medical institutions to be confirmed from homes.

What is claimed is:

1. A medical information display apparatus, comprising:
a time-line display unit for displaying a time-line representing a time axis on a display unit;
a time-line specification input acceptance unit for accepting a specification input specifying a given period on the time-line;
an electronic medical record retrieval unit for retrieving an electronic medical record of a given subject for an examination received by the subject during the specified period from an electronic medical record storage unit storing numbers of electronic records;
a target examined region extraction unit for extracting an examined region recorded in the retrieved electronic medical record;
an examination information retrieval unit for retrieving examination information associated with the examined region from an examination information storage unit storing numbers of examination information;
a hierarchical image storage unit storing hierarchical images constituted by an appearance image representing an appearance of a body and a plurality of gradually magnified anatomy images schematically representing anatomical structures present inside of the body in which the plurality of anatomy images is ranked such that the higher the magnification rate the lower is the rank with the appearance image being ranked highest;
a hierarchical image display unit for displaying one of the hierarchical images on the display unit;
a specification input acceptance unit for accepting a specification input specifying a desired position in the image displayed on the display unit;
a hierarchical image switch and display control unit for switching the image displayed by the hierarchical image display unit to an anatomy image ranked lower than the displayed image to display the anatomy image according to the specification input accepted by the specification input acceptance unit in which an image including a structure present at the specified position in the switched anatomy image is displayed on the display unit; and
an examination information switch and display control unit for switching the image displayed by the hierarchical image display unit to the retrieved examination information to display the examination information if the structure present at the position specified by the specification input accepted by the specification input acceptance unit corresponds to the examined region.

2. The medical information display apparatus of claim 1, further comprising an examined region mark display unit for displaying a mark representing the extracted examined region on a position in the appearance image corresponding to the extracted examined region in a superimposing manner.

3. The medical information display apparatus of claim 1, wherein the examination information switch and display control unit is a unit that switches the image displayed by the hierarchical image display unit to the retrieved examination information to display the examination information only when the image displayed by the hierarchical image display unit is an anatomy image magnified by a predetermined magnification rate or greater.

4. The medical information display apparatus of claim 2, wherein the examination information switch and display control unit is a unit that switches the image displayed by the hierarchical image display unit to the retrieved examination information to display the examination information only when the image displayed by the hierarchical image display unit is an anatomy image magnified by a predetermined magnification rate or greater.

5. The medical information display apparatus of claim 1, wherein the hierarchical image switch and display control unit is a unit that displays the image including a structure corresponding to the examined region if the structure corresponding to examined region is present adjacent to the position specified by the specification input acceptance unit.

6. The medical information display apparatus of claim 1, wherein the time-line specification input acceptance unit is a unit that accepts an input from any one of a mouse, keyboard, and touch panel provided on the display unit.

7. The medical information display apparatus of claim 1, wherein the specification input acceptance unit is a unit that accepts an input from any one of a mouse, a keyboard, and a touch panel provided on the display unit.

8. The medical information display apparatus of claim 1, wherein the examination information is a medical image.

9. An operation method for operating a medical information display apparatus which includes:
a time-line display unit for displaying a time-line;
a time-line specification input acceptance unit for accepting a specification input specifying a given period;
an electronic medical record retrieval unit for retrieving an electronic medical record;
an examined region extraction unit for extracting an examined region;
an examination information retrieval unit for retrieving examination information;
a hierarchical image storage unit storing hierarchical images constituted by an appearance image representing an appearance of a body and a plurality of gradually magnified anatomy images schematically representing anatomical structures present inside of the body in which the plurality of anatomy images is ranked such that the higher the magnification rate the lower is the rank with the appearance image being ranked highest;
a hierarchical image display unit for displaying one of the hierarchical images on the display unit;
a specification input acceptance unit for accepting a specification input specifying a desired position in the displayed image;
a hierarchical image switch and display control unit for switching the displayed image to an anatomy image to display the anatomy image; and
an examination information switch and display control unit for switching the displayed image to the retrieved examination information to display the examination information, wherein the method comprising:
a time-line display step for displaying, by the time-line display unit, a time-line representing a time axis on a display unit;
a time-line specification input accepting step for accepting, by the time-line specification input acceptance unit, a specification input specifying a given period on the time-line;
an electronic medical record retrieval step for retrieving, by the electronic medical record retrieval unit, an electronic medical record of a given subject for an examination received by the subject during the specified period from an electronic medical record storage unit storing numbers of electronic records;
a target examined region extraction unit for extracting an examined region recorded in the retrieved electronic medical record;
an examination information retrieval step for retrieving, by the examination information retrieval unit, examination information associated with the examined region from an examination information storage unit storing numbers of examination information;
a hierarchical image display step for displaying, by the hierarchical image display unit, one of the hierarchical images on the display unit;
a specification input accepting step for accepting, by the specification input acceptance unit, a specification input specifying a desired position in the image displayed on the display unit;
a hierarchical image switch and display control step for switching, by the hierarchical image switch and display control unit, the image displayed by the hierarchical image display unit to an anatomy image ranked lower than the displayed image to display the anatomy image according to the specification input accepted by the specification input acceptance unit in which an image including a structure present at the specified position in the switched anatomy image is displayed on the display unit; and
an examination information switch and display control step for switching, by the examination information switch and display control unit, the image displayed by the hierarchical image display unit to the retrieved examination information to display the examination information if the structure present at the position specified by the specification input accepted by the specification input acceptance unit corresponds to the examined region.

10. A nontransitory recording medium on which is recorded a medical information display program for causing a computer to function as:
a time-line display unit for displaying a time-line representing a time axis on a display unit;
a time-line specification input acceptance unit for accepting a specification input specifying a given period on the time-line;
an electronic medical record retrieval unit for retrieving an electronic medical record of a given subject for an examination received by the subject during the specified period from an electronic medical record storage unit storing numbers of electronic records;
a target examined region extraction unit for extracting an examined region recorded in the retrieved electronic medical record;
an examination information retrieval unit for retrieving examination information associated with the examined region from an examination information storage unit storing numbers of examination information;
a hierarchical image storage unit storing hierarchical images constituted by an appearance image representing an appearance of a subject body and a plurality of gradually magnified anatomy images schematically representing anatomical structures present inside of the body in which the plurality of anatomy images is ranked such that the higher the magnification rate the lower is the rank with the appearance image being ranked highest;
a hierarchical image display unit for displaying one of the hierarchical images on the display unit;
a specification input acceptance unit for accepting a specification input specifying a desired position in the image displayed on the display unit;
a hierarchical image switch and display control unit for switching the image displayed by the hierarchical image display unit to an anatomy image ranked lower than the displayed image to display the anatomy image according to the specification input accepted by the specification input acceptance unit in which an image including a structure present at the specified position in the switched anatomy image is displayed on the display unit; and
an examination information switch and display control unit for switching the image displayed by the hierarchical image display unit to the retrieved examination information to display the examination information if the structure present at the position specified by the specification input accepted by the specification input acceptance unit corresponds to the examined region.
